(19) United States
(12) Patent Application Publication
(10) Pub. No.: US 2020/0259226 A1
(43) Pub. Date: Aug. 13, 2020

(54) MULTI-CELL BATTERY MODULE

(71) Applicant: Dr. Ing. h.c. F. Porsche Aktiengesellschaft, Stuttgart (DE)

(72) Inventor: Ralf Keller, Pforzheim (DE)

(21) Appl. No.: 16/787,187

(22) Filed: Feb. 11, 2020

(30) Foreign Application Priority Data
Feb. 11, 2019 (DE) 10 2019 103 283.0

(51) Int. Cl. H01M 10/625; H01M 10/647; H01M 2/10; H01M 10/6555; H01M 10/653

(52) U.S. Cl. CPC H01M 10/625; H01M 10/647; H01M 10/653; H01M 10/6555; H01M 2/1077

(57) ABSTRACT

A multi-cell battery module (20) for a traction battery (12) of a motor vehicle (10) traveling in a forward direction (V) has a module housing (22) with a metal bottom wall (27), and a plurality of plate-like and deformable pouch battery cells (301-305) arranged in the module housing (20) vertically, parallel to one another and projecting in the transverse direction to the forward direction. A non-adhesive and non-cured thermally conductive potting compound (50) is poured in in a manner directly adjoining the bottom wall (27) and in thermal contact with the bottom wall (27). The thermally conductive potting compound makes thermal contact with the lower ends of the pouch battery cells (301-305).

### CROSS REFERENCE TO RELATED APPLICATION

This application claims priority under 35 USC 119 to German Patent Appl. No. 10 2019 103 283.0 filed on Feb. 11, 2019, the entire disclosure of which is incorporated herein by reference.

### BACKGROUND

### Field of the Invention

The invention relates to a multi-cell battery module for an underbody traction battery of a motor vehicle traveling in a forward direction.

### Related Art

The traction battery of a motor vehicle that has an electric traction drive includes plural multi-cell battery modules, each of which has plural plate-like battery cells. The traction battery generally is arranged in the motor vehicle underbody and can therefore be deformed considerably in the event of a side-on collision. When the battery modules are arranged such that the battery cells in the battery module are oriented transverse to the forward direction of the traveling motor vehicle, that is to say project in a vertical plane or in a horizontal plane, the battery cells also are deformed considerably when the battery module is deformed, and specifically substantially in a transverse direction that lies in the bottom plane of the plate-like battery cell. The battery cells thus are compressed significantly.

DE 10 2014 210 572 A1 discloses thermally connecting the respective battery cells projecting in a vertical plane to the bottom wall by means of solid-state thermally conductive bodies to produce a good heat transfer from the battery cells to the actively cooled bottom wall of the module housing of the battery module.

As a result, the respective battery cells are fixed mechanically to the bottom wall. In the event of a side-on collision, the battery cells also are deformed plastically by the deformation of the bottom wall. A significant fire risk results from greatly deformed battery cells.

It is an object of the invention to provide a multi-cell battery module of a traction battery having a reduced fire risk in the event of a collision.

### SUMMARY

The invention relates to a multi-cell battery module for a traction battery of a motor vehicle traveling in a forward direction, in particular for an underbody traction battery. The battery modules has a module housing having a metal bottom wall that has a good thermal conductivity. Plate-like and deformable pouch battery cells are arranged in the module housing. The pouch battery cells being arranged with their ground plane vertical, parallel to one another and projecting in the transverse direction to the forward direction of the motor vehicle. The vertical arrangement of the battery cells is therefore advantageous because in this way all of the battery cells can be cooled in a relatively simple manner via the bottom wall of the module housing.

A non-adhesive and non-cured thermally conductive potting compound is filled in in a manner directly adjoining the bottom wall and in thermal contact with the bottom wall. The thermally conductive potting compound makes thermal contact with the lower ends of the pouch battery cells. The elastic and/or even to a lesser extent slightly viscous thermally conductive potting compound is in contact by way of its boundary layers on the one hand very closely with the surface of the bottom wall and on the other hand with the relevant surface of the battery cells. Thus, a good heat transfer to the boundary areas is ensured here in each case. The battery cells abut or are in contact with only the boundary layer of the thermally conductive potting compound, but are not mechanically connected thereto in a materially bonded, or force-fitting or form-fitting manner. Due to the elastic or plastic deformability of the thermally conductive potting compound, no forces or only low forces are transmitted from the module housing bottom wall to the battery cells in the event of a collision. The battery cells are mounted inside the module housing in a floating manner. The battery cells are pouch battery cells. Thus, upon compression of the module housing from outside, the pouch battery cells can yield mechanically without necessarily becoming damaged or destroyed in the process due to their good plastic deformation ability. As a result, the risk of fire in the event of a side-on collision is reduced significantly.

The thermally conductive potting compound of one embodiment has a specific thermal conductivity of greater than 2.5 Watt/Milli-Kelvin. As a result, a sufficient heat transfer from the battery cells to the bottom wall of the module housing is ensured.

The thermally conductive potting compound may have a viscosity of at least 50-150 mPa·s at room temperature. The thermally conductive potting compound is thus at a minimum viscous, but still can be introduced into the module housing in a flowing manner like a liquid and behaves in a very sluggish manner in the case of accelerations acting thereon.

Alternatively, the thermally conductive potting compound can be formed by a mat that is laid into the module housing before the battery cells are inserted into the module housing.

The thermally conductive potting compound of some embodiments has an ignition temperature of over 300° C. and may be provided with fire retardants that bring about self-extinguishing of the thermally conductive potting compound as soon as the heat source is removed.

The thermally conductive potting compound may be a polymer base and is free of silicone.

An intermediate cell filling may be arranged in each case between two adjacent battery cells. The intermediate cell filling is not in each case mechanically connected to the two adjoining battery cells. The intermediate cell filling serves to mechanically space the battery cells apart from one another, is thermally conductive and likewise elastically and/or plastically deformable. The intermediate cell filling can be the substance of the thermally conductive potting compound and may be what is known as a compression mat.

The module housing bottom wall may have at least one filling opening that is closed by the locally cured thermally conductive potting compound. The thermally conductive potting compound inside the module housing may not be cured. In the region of the filling opening, however, said thermally conductive potting compound is cured, for example, by way of appropriate local UV light irradiation. During production of the battery module, the viscous thermally conductive potting compound can be poured into the bottom region from below through the filling opening. As soon as the thermally conductive potting compound is poured into the module housing to the intended extent, the filling process is stopped and the portion of the thermally conductive potting compound inserted in the filling opening is cured by way of a corresponding treatment, for example irradiation with UV light, with the result that the filling opening is closed in a fluid-tight manner in this way.

An exemplary embodiment of the invention is explained in more detail in the following text with reference to the drawings.

### BRIEF DESCRIPTION OF THE DRAWINGS

FIG. 1 schematically shows a plan view of a motor vehicle driving in a forward direction having an underbody traction battery that has a plurality of multi-cell battery modules.

FIG. 2 is a vertical cross section II-II of a battery module of FIG. 1.

FIG. 3 is a horizontal longitudinal section III-III of the battery module of FIGS. 1 and 2.

FIG. 4 is a vertical longitudinal section IV-IV of the battery module of. 1-3.

### DETAILED DESCRIPTION

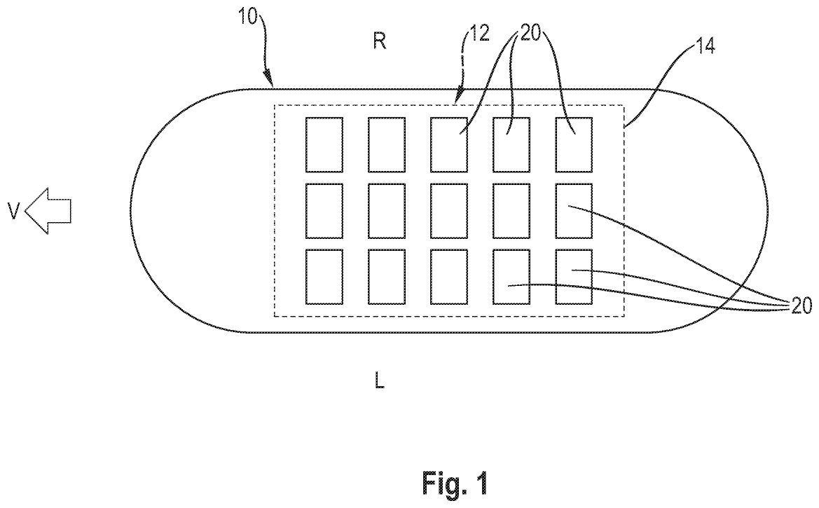

FIG. 1 schematically illustrates a plan view of a motor vehicle 10, which is traveling in a forward direction V and has a left side L and a right side R. In the bottom region, the motor vehicle 10 has a traction battery 12, which consists of a plurality of identical multi-cell battery modules 20, which are arranged inside a traction battery housing 14.

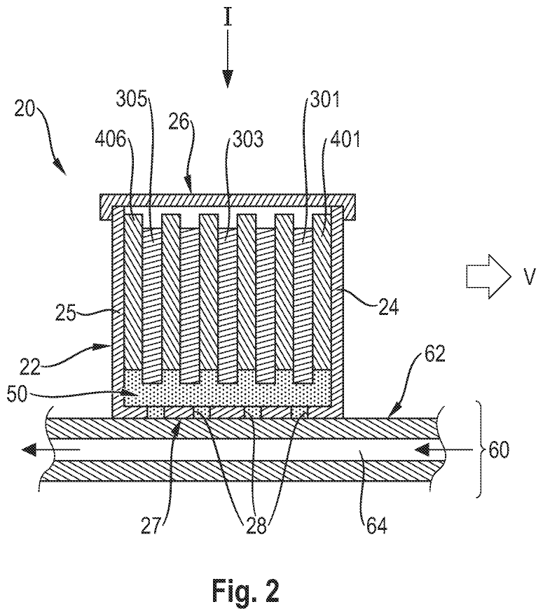

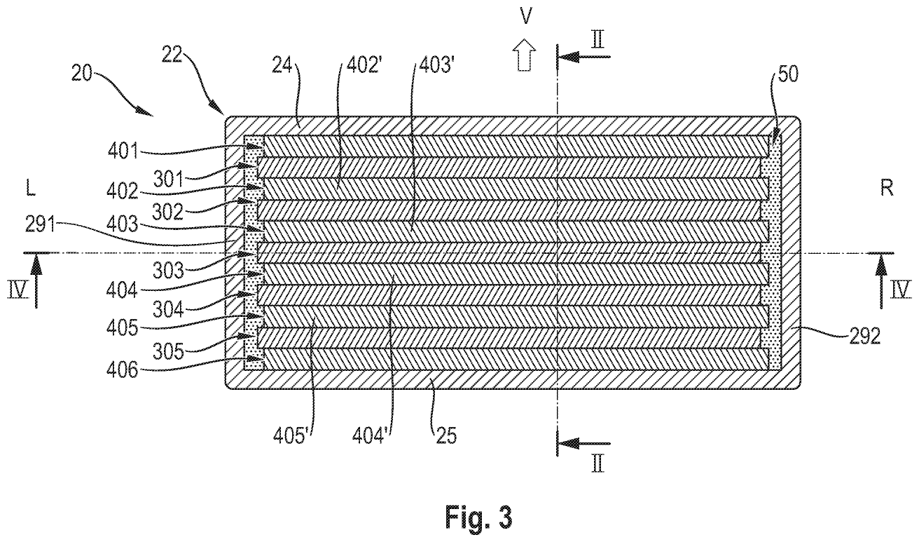

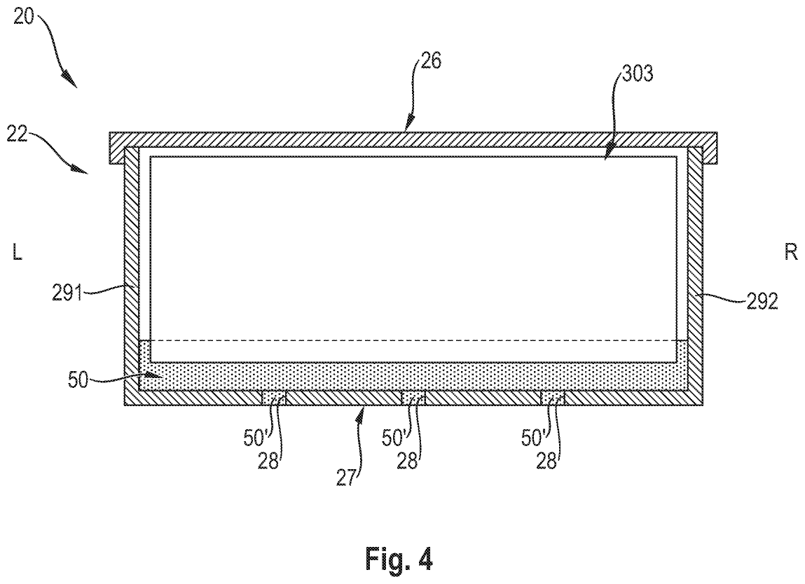

A multi-cell battery module 20 is illustrated in detail in FIGS. 2-4. The battery module 20 has a rectangular module housing 22 with six walls, namely a metal bottom wall 27 lying in a horizontal plane, a front wall 24 projecting in a vertical plane, a rear wall 25 projecting in a vertical plane, right and left side walls 292, 291 projecting in a vertical plane and also a housing cover 26 lying in a horizontal plane. The vertical walls 24, 25, 291, 292 and/or the housing cover 26 may also consist of metal, and thereby have a high mechanical strength and good thermal conductivity properties.

Five plate-like pouch battery cells 301-305 are arranged inside the module housing 22 and are non-destructively deformable to a certain extent. The pouch battery cells project in each case with their ground plane in a vertical plane and being arranged parallel to one another. The battery modules 20 are arranged in the traction battery housing 14 in such a way that the battery cells 301-305 project in a transverse plane relative to the forward direction V of the vehicle 10.

As illustrated in FIG. 2, the battery module 20 projects with its bottom wall 27 on a bottom wall 60 of the traction battery housing 14, and a cooling liquid cooling channel 64 is in the bottom wall 60 of the traction battery housing 14.

The module housing bottom wall 27 is covered over the whole area with a thermally conductive potting compound 50, into which the lower ends of all of the battery cells 301-305 are immersed. However, the battery cells 301-305 are not supported by the thermally conductive potting compound 50. The thermally conductive potting compound 50 has a polymer base and is free of silicone. The thermally conductive potting compound 50 has an ignition temperature of over 300° C. and also comprises fire retardants that promote self-extinguishing of the thermally conductive potting compound 50.

The thermally conductive potting compound 50 is non-adhesive and is not cured but is elastic to a certain extent and also viscous to a certain extent. As a result, a good heat transfer exists at the boundary layer between the thermally conductive potting compound 50 and both the battery cell 301-305 and the battery module bottom wall 27.

The thermally conductive potting compound 50 also transmits only very low mechanical forces between the battery module bottom wall 27 and the battery cells 301-305. As a result, in the event of a side-on collision, upon compression of the module housing 22 in the transverse direction, the battery cells 301-305 are likewise only simply compressed but not also additionally twisted by forces introduced via the bottom wall 27. As a result, the chance of substantially damage-free deformation of the battery cells 301-305 in the event of a side-on collision is increased considerably, which in turn considerably reduces the risk of fire.

Respective intermediate cell fillings 401-406 are arranged between the battery cells 301-305 and between the frontmost battery cell 301 and the front wall 24 and between the rearmost battery cell 305 and the rear wall 25. The intermediate cell fillings are not being mechanically fixed to the adjacent areas, for example to the adjacent battery cells 301-305, such that a floating mounting of the battery cells 301-305 is also able to be realized. The intermediate cell filling 402-404 is in the present case respectively formed by what is known as a compression mat 402′-404′.

A plurality of filling openings 28 are provided in the bottom wall 27 of the battery module 20, and the viscous thermally conductive potting compound 50 is poured through the filling openings 28 during assembly. After the desired quantity of the thermally conductive potting compound 50 has been poured in, the portion of the thermally conductive potting compound inserted in the filling opening 28 is cured, for example by local application of UV light in this region. As a result, all of the filling openings 28 are closed by way of cured thermally conductive potting compound 50′ in such a way that no thermally conductive potting compound 50 can escape from the interior of the battery module 20 through the filling openings 28.

What is claimed is:

1. A multi-cell battery module for a traction battery of a motor vehicle traveling in a forward direction, comprising
a module housing, which has a metal bottom wall, and
a plurality of plate-like and deformable pouch battery cells, which are arranged in the module housing vertically, parallel to one another and projecting in the transverse direction to the forward direction,
wherein a non-adhesive and non-cured thermally conductive potting compound is poured in in a manner directly adjoining the bottom wall and in thermal contact with the bottom wall, said thermally conductive potting compound making thermal contact with the lower ends of the pouch battery cells.

2. The multi-cell battery module of claim 1, wherein the thermally conductive potting compound has a specific thermal conductivity of greater than 2.5 W/mKelvin.

3. The multi-cell battery module of claim 2, wherein the thermally conductive potting compound has a viscosity of at least 50-150 mPa·s.

4. The multi-cell battery module as claimed in either of claim 1, wherein the thermally conductive potting compound is formed from a mat.

5. The multi-cell battery module of claim 1, wherein the thermally conductive potting compound has an ignition temperature of over 300° C.

6. The multi-cell battery module of claim 5, wherein the thermally conductive potting compound comprises fire retardants.

7. The multi-cell battery module of claim 1, wherein the thermally conductive potting compound is free of silicone and/or has a polymer base.

8. The multi-cell battery module of claim 1, wherein a respective intermediate cell filling is arranged between the battery cells, which respective intermediate cell filling is not mechanically connected to the adjoining battery cell.

9. The multi-cell battery module of claim 8, wherein the intermediate cell filling is formed by a compression mat.

10. The multi-cell battery module of claim 1, wherein the bottom wall has at least one filling opening that is closed by the locally cured thermally conductive potting compound.
